(19) United States
(12) Patent Application Publication
(10) Pub. No.: US 2015/0179030 A1
(43) Pub. Date: Jun. 25, 2015

(54) MONITORING DEVICE

(71) Applicant: AES ENGINEERING LTD, Rotherham (GB)

(72) Inventors: Stephan Mottershead, Buckinghamshire (GB); Simon Robert Watson Mills, Leicestershire (GB)

(73) Assignee: AES Engineering Ltd., Rotherham, OT (GB)

(21) Appl. No.: 14/403,567

(22) PCT Filed: May 21, 2013
(86) PCT No.: PCT/GB2013/000234

§ 371 Date: Nov. 24, 2014

(30) Foreign Application Priority Data
May 22, 2012 (GB) GB1209225.0

(51) Int. Cl. G08B 5/36; G08B 21/18

(52) U.S. Cl. CPC G08B 5/36; G08B 21/187

(57) ABSTRACT

A condition monitoring device for attachment to a machine and for monitoring the condition thereof includes at least one sensor for monitoring at least one parameter of the machine, and a processor connected to the one or more sensors for analyzing the signals produced therefrom. A wireless transmitter and a wireless receiver is connected to the processor and permits external communication therewith. The condition monitoring device further includes at least one visual indicator of the status of the monitored machine based upon the sensed parameter.

### FIELD OF THE INVENTION

This invention relates to a monitoring device for monitoring the condition of machinery.

### BACKGROUND TO THE INVENTION

Machinery, especially machinery with moving parts, can, over time, develop problems during operation. This may be due to misalignment of parts, wear on parts or other issues, which may subsequently lead to further problems and failure.

Condition based maintenance (CBM) and condition monitoring (CM) is the detection of symptoms through the measurement of one or more parameters which may be indicative of a fault condition, either by an increase or decrease in the overall measured value, or by some other change to a characteristic value such as root-mean-square value (r.m.s.), peak value (pk), frequency component amplitude, pattern and/or distribution, etc.

Vibration monitoring (VM) is a particular technique used in condition monitoring. Vibration is the mechanical movement of a machine or asset which may be periodic (regular) or random and contains characteristic symptoms of a wide range of machine faults, including: unbalance, misalignment, poor bearing lubrication, gear faults, motor winding & rotor faults, bearing damage, etc. It is particularly effective for monitoring rotating and reciprocating machines. Vibration monitoring utilises vibration sensors or transducers to detect the vibration signal. The vibration signal may then be conditioned, filtered and processed using analysis instrumentation and software.

Common sources of poor vibration measurements, which limits the efficiency of CM arrangements, include, poor sensor contact, faulty attachment, operator error, cable faults, ground loop, transducer fault, instrument fault, low instrument voltage and/or change of probe/magnet.

Various transducers are available for detecting vibrations in machinery and one particular system uses a portable digital assistant (PDA), which connects to a sensor device using a cable to download the information. The information can then be uploaded to a web-based server from the PDA. One of the problems with such an arrangement is that a user needs clear access to the device in order to upload information via a cable. Additionally, one not trained to interrogate the device is unlikely to identify any issues that may occur during use of the machines. Therefore, a problem may go unnoticed until a trained user is able to attend the site, interrogate the device and interpret the information collected. Furthermore, where a user needs access to the device, it may not be possible to locate the device in a position in which an efficient and effective reading may be taken, thereby limiting the use of the device.

### SUMMARY OF THE INVENTION

Accordingly, the present invention is directed to condition monitoring device for attachment to a machine and for monitoring the condition thereof, comprising:

at least one sensor for monitoring at least one parameter of the machine;
a processor connected to the at least one sensor for analysing the signals produced therefrom;
a wireless transmitter and a wireless receiver connected to the processor and allowing external communication therewith;
a battery connected to the processor;
and at least one visual indicator of the status of the monitored machine based upon the sensed parameter.

The use of a visual indictor on the device itself allows for a lay-person to observe that the monitored machine is working correctly without requiring any expert knowledge. During routine, or scheduled, checks, the information from the device can be transmitted wirelessly to a PDA or other receiving device. The use of the wireless transmission provides for a quicker and safer download of the data. Additionally, or alternatively, the information can be continuously transmitted to a server so that real-time monitoring can be undertaken.

Preferably, an analogue to digital interface is provided between the sensor and the processor to covert the sensed parameter into a digital signal. Converting the analogue signal to a digital format allows easier transmission and analysis of the sensed parameter.

Advantageously, the sensed parameter is vibration. Whilst various parameters can be measured either alone or in combination, vibration of the machine is a preferred parameter to measure as it may be indicative of imbalance, misalignment, poor bearing lubrication, gear faults, motor winding and rotor faults and/or bearing damage.

In a preferred construction the device further comprises internal memory to store information on the monitored parameter over a period of time. The device may be set to measure the selected parameter periodically or to record when changes occur to the parameter, either from the previous reading or from a defined level. Being able to record that information over time in an internal memory allows one to analyse the performance of the machinery and any anomalies are more easily identified. Additionally, small, potentially insignificant, changes can be monitored. The internal memory may be sealed within the device and the information transmitted wirelessly. Alternatively, the memory may be removable from the device to allow for it to be taken away and analysed, if required, in which case the device may be provided with expandable memory options. The data from the memory may be exported for further analysis.

It is advantageous that the at least one sensor comprises a component selected from a group comprising: an IEPE accelerometer; a micro-electro-mechanical system accelerometer; seismic velocity sensor; and an eddy-current proximity sensor. Various transducers and/or sensing arrangements may be used in the device to monitor various parameters. The group of sensors provided may be used to accurately detect small changes in parameters such as vibration. Additionally, sensors that are of a relatively small size, for example micro-electro-mechanical system (MEMs) devices can be incorporated into the device to ensure that it is sufficiently small to not inhibit use of the machinery and to allow it to be placed in a useful position on the machinery to monitor the parameter(s) efficiently.

In one construction, the at least one visual indicator is a plurality of light-emitting diodes, and in particular, a plurality of light-emitting diode arrays are provided, each comprising at least 3 different colours. The use of a plurality of light-emitting diodes (LEDs) allows a plurality of parameters to be monitored and their status clearly identified to an observer. It may be desirable to use a single LED for each parameter but the use of a plurality increases the usefulness of the device. Where more than two different colours are used, the device can provide a range of statuses to an observer rather than a simple, binary, indication. This gives a meaningful traffic-light display system to provide a person with information on the running of the machinery without requiring any data transfer or interrogation of the device. Where more information is required, interrogation of the device can be undertaken.

Advantageously, the light emitting diode arrays are positioned to provide a visual signal within a translucent plastics material at one end of the device. The LEDs may be contained within translucent or transparent discs of plastics material, particularly PMMA, which allows the light emitted to be seen from any position around the device. Alternatively, the LEDs may be contained within the body of the device and a lens and optical light guide, or an optical fibre, used to provide the optical signal to the plastics material. This allows observation of the signal from any direction, thereby giving a clear indication of the status of the machine and its measured parameter regardless of the position of the device on the machinery. With the discs layered on top of one another and each corresponding to a different parameter or status, the device can be easily and quickly read and any anomalies spotted and identified immediately, without the user requiring specialist training.

It is preferable that the device further comprises a timing mechanism to allow the device to record the at least one parameter at regular intervals. This allows for regular readings to be taken so that a profile of the machinery's status over time can be recorded.

The invention provides a self-contained battery-powered sensor with one or more remotely selectable on-board monitoring parameters with adjustable warning and alarm limits, and the capability for bi-directional communication and configuration without cables. Configuration includes: parameter alarms, acquisition and/or wake-up frequency, sampling rate and number of samples. The battery may be able to last several years before requiring replacement or recharging. It may be desirable to provide a charging socket or for the battery to be wirelessly chargeable.

Examples of parameters that may be monitored include:

Overall r.m.s. velocity, which may be used to detect direct mechanical faults, for example imbalance, looseness, misalignment and/or pump flow errors;
True r.m.s. acceleration, which may be used in the early identification of certain bearing faults, for example poor lubrication or loss of clearance, and may also be used for detection of pump process faults, for example cavitation;
True peak acceleration, which may be used to detect bearing damage, for example impacts, shocks, pitting and/or spalling; and
Surface temperature, which may identify bearing rubbing, a loss of clearance and process problems.

The invention extends to a system comprising the condition monitoring device and a handheld device for communicating with and programming the condition monitoring device, wherein the handheld device comprises:

a processor connected to a wireless transmitter and a wireless receiver allowing communication with the condition monitoring device;
internal memory to which the information received from the condition monitoring device is recorded;
a user display to allow a user to interact with the processor; and
condition monitoring and analysis software to process and manage the dynamic vibration signal waveform received from the condition monitoring device.

The device also allows monitoring of machinery that would otherwise have been inaccessible, hazardous or restricted by the use of a wireless sensor, or transducer, and portable handset for reading/configuring the device. The invention further overcomes many common sources of poor vibration measurements by using a sensor that is permanently fixed to the machinery with a build-in status indicator.

### BRIEF DESCRIPTION OF THE DRAWINGS

An embodiment of the invention will now be described, by way of example only, and with reference to the accompanying drawings, in which:

FIG. 1 is a diagram showing the arrangement of components in a device in accordance with the present invention;

FIG. 2 is a perspective view of a device in accordance with the present invention;

FIG. 3 is an exploded view of the device shown in FIG. 2;

FIG. 4 is a side view of the device shown in FIG. 2; and

FIG. 5 is an exploded view of the device shown in FIG. 4.

### DETAILED DESCRIPTION OF EXEMPLARY EMBODIMENTS

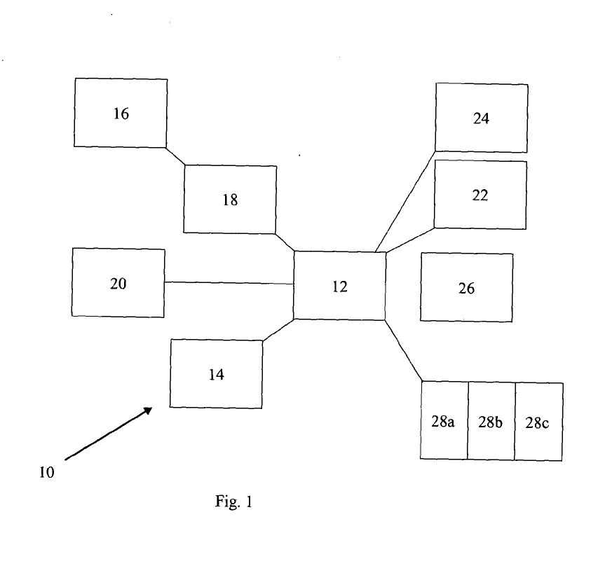

FIG. 1 shows a device 10 having a central processor 12 connected to a power supply 14 in the form of a battery. The device comprises a MEMs accelerometer 16, which is connected to the processor 12 via an analogue to digital converter 18. The processor 12 is also connected to an input in the form of a temperature sensor 20.

A transmitter 22 and a receiver 24 are provided and are in communication with the processor 12. The device is provided with memory 26 connected to the processor 12 and a visual indicator in the form of a plurality of LEDs 28 is also connected to the processor 12. The LEDs 28 each correspond to a particular measured or calculated parameter.

When in use, the device 12 is connected to the machinery to be monitored and the MEMs sensor 16 monitors vibration levels. The received signal is passed through the analogue to digital converter 18 to the processor 12, where it can be analysed. The processor 12 is given a default setting to provide the following information from the signal received:

Vibration overall velocity amplitude (r.m.s.) derived from a power spectrum in units of mm/s;

Vibration overall acceleration amplitude (r.m.s.) derived from the vibration acceleration waveform in units of g (where g=9.81 m/s²); and

Vibration peak acceleration amplitude (pk) derived from the vibration acceleration waveform in units of g (where g=9.81 m/s²).

The calculated values are then compared to a predetermined limited and an appropriate level of concern attached to that value. The processor 12 then sends a signal to the visual indicators 28 according to the level of concern assigned to the parameter. For example, different colours may be displayed according to where the parameter is located on a scale; the colour displayed may vary according to whether the measurement or calculated value is below the predetermined ‘safe’ range, within range, above the range (warning) significantly above the range (alarm) and alarmingly above the range (alarm).

The temperature sensor 20 may be provided with a visual indicator in order to indicate when the temperature of the machinery is above a predetermined threshold.

The information received by the processor 12 from the sensor 16, and any values calculated from that data, may be recorded in the memory 26, which is non-volatile memory. The data can then be accessed as and when required and the data for the machinery over time can be available to a user. The data may be undeletable so that it stays with the machinery and anyone needing to review the machinery will have access to the data from the lifespan of the machinery, or at least from when the device 10 was installed. Where machinery fails, the memory 26 can be recovered and interrogated to provide information on the cause of the failure.

The memory 26 may be used to store a time trace, especially a vibration acceleration time trace, which allows processing of acceleration, velocity and displacement spectra. The sampling frequency and rate and the number of samples can be configured by the user.

The transmitter 22 and the receiver 24, which are powered by the battery 14, allow a user to communicate with the processor 12 and to access the memory 26. The user can download information from the device 10, or can programme the processor 12 to adjust the predetermined values or to configure/reconfigure it to calculate different parameters. The transmitter 22 and receiver 24 may be in the form of a short-range radio transmission device, for example Bluetooth®, or another form of wireless transmission or wireless data exchange. Where the system forms part of a commonly used form of wireless transmission, it can send and receive information to and from a PDA, a smartphone, a laptop computer and/or a tablet. Where a wireless network is set up, the device 10 may be connected to that network to allow the transmission and reception of information in real time.

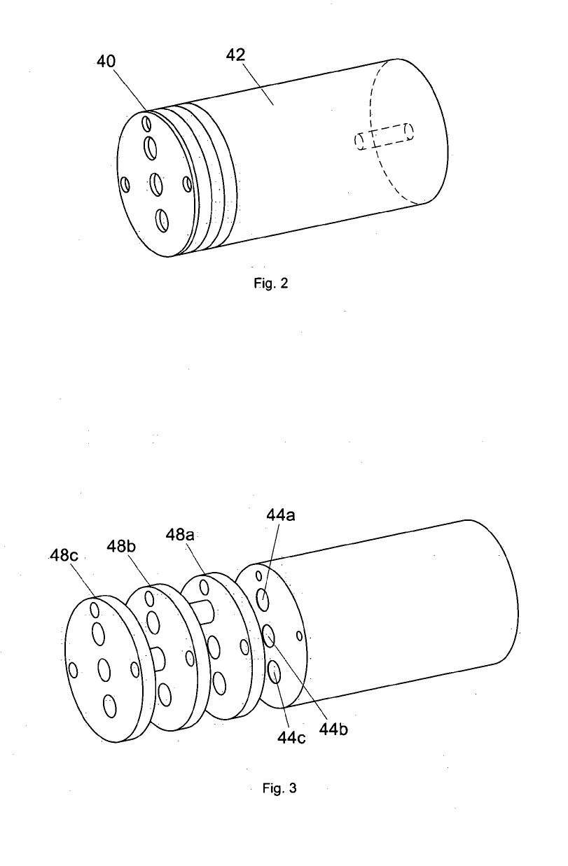

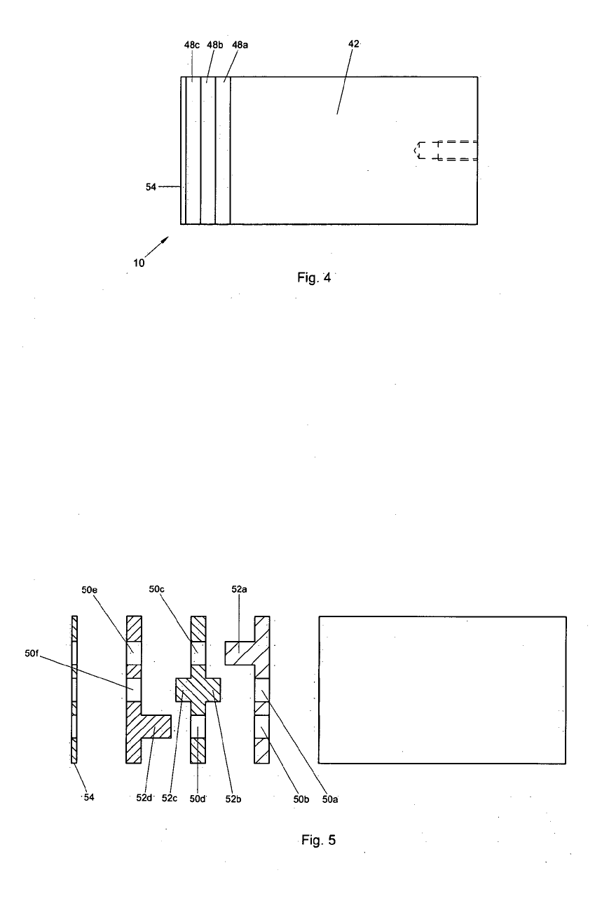

FIGS. 2 to 5 show an embodiment of the device 10 having a visual indicator system 40. The device 10 comprises a body section 42, in which the components allowing condition monitoring of machinery are held, with the visual indicator system 40 at one end. The visual indictor system comprises a plurality of LED arrangements (not shown) contained in a recess within the body 42, with each arrangement corresponding to a different measured parameter. Each recess containing the LED arrangement is open to the end of the body 42 and the open end of each recess is covered by a respective LED lens 44.

The lenses are covered by three coaxially-positioned plastics material discs 48, layered on top of one another. Discs 48 are all of the same thickness and interlock to form a column. The discs 48 are provided with recesses 50 and protrusions 52 having lengths that are multiples of the thickness of the discs 48, such that they slot together with at least one section of each disc 48 being visible from an end view of the visual indicator system 40. The protrusions 52 act as light guides. A metal end cover 54 is positioned over the disc 48 that is furthest from the body section 42. The cover 54 has apertures in its face to allow a user to see the section of each disc 48 that is visible from the end.

The first disc 48a is provided with two apertures 50a and 50b and one protrusion 52a such that the disc 48a has a flat side and a protrusion side. The flat side of the disc 48a is connected to the end of the body section 42 such that the lens 44a is aligned with the rear side of protrusion 52a. The apertures 50a and 50b are aligned with the other two lenses 44b and 44c so that light from those lenses is not obscured by the disc 48a and passes therethrough unaffected.

The second disc 48b is provided with two apertures 50c and 50d and two protrusions 52b and 52c extending both forward and rearward from the corresponding faces of the disc 48b, respectively. The second disc 48b is positioned over the first disc 48a with the first aperture 50c of the second disc 48b slotting over the protrusion 52a of the first disc 48a. The rearward protrusion 52b of the second disc 48b slots into the first aperture 50a of the first disc 48a. The second aperture 50d of the second disc 48b is aligned with the second aperture 50b of the first disc 48a. Light from the second lens 44b is directed to the rearward protrusion 52b of the second disc 48b and the light from the third lens 44c is permitted to pass through the first disc 48a and the second disc 48b.

The third disc 48c is provided with two apertures 50e and 50f and a single rearward facing protrusion 52d, such that the disc 48c has a flat surface and a surface with the protrusion 52d. The first aperture 50e and the second aperture 50f are slotted over the protrusion 52a of the first disc 48a and the forward facing aperture 52c of the second disc 48b. The protrusion 52d of the third disk 48c slots into the aperture 50b of the first disc 48a and the aperture 50d of the second disc 48b so that the protrusion is positioned immediately adjacent the lens 44c.

The metal end cover 54 is attached to the flat surface of the third disc 48c with the apertures within that cover aligned with the position of the three protrusions 50 in the third disc 48c. A screw or similar attachment device may be used to retain the discs 48 and metal cover 54 on the body 42 of the device 10.

The faces of the discs 48, apart from the protrusions are coated with an opaque material, such as matt black paint, to prevent light passing to an adjacent disc. Other coatings, such as metallic foil may be used, or a layer of material positioned between each of the interlocking discs. It may be desirable to have relatively thick layers of material between each disc to more clearly distinguish the discs when they are fixed to the body 42 of the device 10 and to prevent colour ‘bleeding’ from one disc to an adjacent disc. Alternatively, or additionally, the refractive index for each material may be chosen to obtain the same result. The edges of the discs are designed to show the colour of light and so are left substantially clear of any coatings.

As a result of this arrangement, a user can determine the colour of light emitted from the lenses 44 by viewing the visual indicator arrangement 40 from the end or from the side of the device 10, or an angle thereto. With each of the discs 48 corresponding to a different measured or calculated parameter, the status of the machinery in relation to those parameters is immediately clear when viewing the device 10. As an example, the LED arrangements may correspond to the overall r.m.s. velocity, true r.m.s. acceleration and true peak acceleration of the machinery.

The present invention allows for a stand-alone vibration and/or temperature monitor with 360-degree visual parameter traffic-light alarm indication. Additionally, the device can be used as part of an intelligent fixed transducer for a vibration data acquisition system, which can be part of an internet-based system. Furthermore, the invention can operate as a wireless vibration and/or temperature transducer on a data acquisition system with or without Internet server capability.

A further LED, or array of LEDs, may be provided to give an indication of the battery level. Additionally, an automatic signal indicating the battery level may be sent over the wireless transmitter periodically or when the device is interrogated.

The device allows for the post mortem storage of multiple dynamic and static measurements, full waveform (time trace) storage for vibration measurements, ISO vibration alarms and configurable alarm sets, frequency ranges (for example, 2 to 250 Hz, 2 to 1000 Hz or 10 to 1000 Hz), and a unique sensor ID (GUID).

Whilst three plastics material discs have been discussed in the specific embodiment, more or fewer discs may be used depending on the requirement and the number of parameters being observed. The number of LED arrangements may also be adjusted accordingly.

The sensor device may be an integrated Electronics Piezo-Electric accelerometer (IEPE).

An audible alarm system and/or an automatic signal transmission programme may be incorporated into the device and, where the measured parameter and/or calculated value is above a particular pre-set level, the device may issue an alert.

A plurality of sensors may be incorporated into the device in order to calculate or measure more than one parameter. Further indicators (visual or otherwise) may be provided to show whether the machinery is operating as expected.

The units in which the data is recorded and the calculated parameters can be adjusted according to the user's requirements using the transmitter and receiver to programme the processor.

The invention integrates a CF2 A-D card and an IEPE transducer power interface board into a combined A-D and IEPE power board. This also includes a Bluetooth interface to the PDA, thus obviating the requirement for a cable and plug PDA data connection.

Although the invention is disclosed as needing a battery, it may be desirable to provide a mains supply to the device to remove the need for a battery.

1-10. (canceled)

11. A condition monitoring device for attachment to a machine and for monitoring the condition thereof, comprising:
a sensor for monitoring at least one parameter of a machine;
a processor connection to said sensor for analyzing signals produced therefrom;
a wireless transmitter and a wireless receiver connector to said processor for allowing external communication therewith; and,
a visual indicator for indicator a status of the machined being monitored based upon said at least one parameter sensed by said sensor.

12. The condition monitoring device for attachment to a machine and for monitoring the condition thereof according to claim 11, further comprising an analog-to-digital interface between said sensor and said processor for converting said at least one parameter sensed by said sensor into a digital signal.

13. The condition monitoring device for attachment to a machine and for monitoring the condition thereof according to claim 11, wherein said parameter is vibration.

14. The condition monitoring device for attachment to a machine and for monitoring the condition thereof according to claim 11, further comprising an internal memory for storing information on said at least one parameter sensed by said sensor over a period of time.

15. The condition monitoring device for attachment to a machine and for monitoring the condition thereof according to claim 11, wherein said sensor includes a component selected from the group consisting of an IEPE accelerometer, a micro-electro-mechanical system accelerometer, a seismic velocity sensor, and an eddy-current proximity sensor.

16. The condition monitoring device for attachment to a machine and for monitoring the condition thereof according to claim 11, wherein said visual indicator is a plurality of light-emitting diodes.

17. The condition monitoring device for attachment to a machine and for monitoring the condition thereof according to claim 16, wherein each light-emitting diode of said plurality of light-emitting diodes has at least three colors.

18. The condition monitoring device for attachment to a machine and for monitoring the condition thereof according to claim 16, wherein said plurality of light-emitting diodes are positioned for providing a signal at one end of said condition monitoring device.

19. The condition monitoring device for attachment to a machine and for monitoring the condition thereof according to claim 11, further comprising a timing mechanism for allowing recordation of said at least one parameter sensed by said sensor at set intervals of time.

20. An apparatus, comprising:
a condition monitoring device for attachment to a machine and for monitoring the condition thereof, comprising:
a sensor for monitoring at least one parameter of a machine;
a processor connection to said sensor for analyzing signals produced therefrom;
a wireless transmitter and a wireless receiver connector to said processor for allowing external communication therewith; and,
a visual indicator for indicator a status of the machined being monitored based upon said at least one parameter sensed by said sensor; and,
a hand-held device for communicating, comprising:
a processor connected to said wireless transmitter and said wireless receiver allowing communication with said condition monitoring device;
an internal memory for recording information received from said condition monitoring device;
a user display for allowing user interaction with said processor; and,
condition monitoring and analysis software for processing and
managing a dynamic vibration signal waveform received from said condition monitoring device.
